(19) United States
(12) Patent Application Publication
(10) Pub. No.: US 2025/0100577 A1
(43) Pub. Date: Mar. 27, 2025

(54) VEHICLE CONTROL SYSTEMS BASED ON VEHICLE CAMERA AND PEDESTRIAN IMAGE PROCESSING

(71) Applicant: GM GLOBAL TECHNOLOGY OPERATIONS LLC, Detroit, MI (US)

(72) Inventors: Roy Uziel, Glvatayim (IL); Oded Bialer, Petach Tikva (IL)

(21) Appl. No.: 18/474,741

(22) Filed: Sep. 26, 2023

(51) Int. Cl. B60W 60/00; B60W 50/06

(52) U.S. Cl. CPC B60W 60/001; B60W 50/06; B60W 2420/403; B60W 2510/18; B60W 2520/00; B60W 2554/4029; B60W 2556/00

(57) ABSTRACT

A method for controlling automated vehicle acceleration and braking includes obtaining an image using at least one vehicle camera of a host vehicle, extracting machine learning model feature inputs based on the obtained image, detecting one or more objects in the obtained image, the one or more objects including at least one pedestrian, assigning attention weights to regions of the obtained image according to locations of the one or more objects in the obtained image, combining the attention weights with corresponding ones of the machine learning model feature inputs according to the regions of the obtained image, executing a machine learning model to generate a crossing intention prediction output associated with the at least one pedestrian, and in response to the crossing intention prediction output exceeding a crossing intention threshold, controlling automatic braking of the host vehicle according to a location of the at least one pedestrian.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure generally relates to vehicle control systems for controlling automated vehicle braking, including machine learning models for predicting pedestrian crossing intention based on image processing of a vehicle camera image.

Some vehicles include vehicle cameras configured to obtain images from a front of the vehicle along a travel path of the vehicle. Automated driving systems may be configured to control acceleration, braking, etc. of vehicle according to objects in front of the vehicle. Pedestrians often stand and wait to cross a road on which the vehicle is travelling, and may be a collision risk if a pedestrian crosses into the road while the vehicle is driving.

### SUMMARY

A method for controlling automated vehicle acceleration and braking includes obtaining an image using at least one vehicle camera of a host vehicle, extracting machine learning model feature inputs based on the obtained image, detecting one or more objects in the obtained image, the one or more objects including at least one pedestrian, assigning attention weights to regions of the obtained image according to locations of the one or more objects in the obtained image, combining the attention weights with corresponding ones of the machine learning model feature inputs according to the regions of the obtained image, executing a machine learning model to generate a crossing intention prediction output associated with the at least one pedestrian, and in response to the crossing intention prediction output exceeding a crossing intention threshold, controlling automatic braking of the host vehicle according to a location of the at least one pedestrian.

In other features, assigning the attention weights includes assigning a first intensity value to a first region of the obtained image corresponding to the at least one pedestrian, and assigning a second intensity value to a second region of the obtained image which does not correspond to the at least one pedestrian, and the first intensity value is greater than the second intensity value.

In other features, combining the attention weights and the machine learning model feature inputs includes generating a weighted sum of the machine learning model feature inputs, according to the attention weights.

In other features, the machine learning model includes a multilayer perceptron, and executing the machine learning model includes generating the crossing intention prediction output according to an output of the multilayer perceptron.

In other features, extracting machine learning model feature inputs based on the obtained image includes supplying the obtained image to multiple visual transformer layers to generate the machine learning model feature inputs.

In other features, executing the machine learning model includes obtaining multiple key values according to the machine learning model feature inputs, executing a classification query according to the machine learning model feature inputs, and correlating a classification query output with the multiple key values.

In other features, executing the machine learning model includes combining the attention weights with a correlation of the classification query output and the multiple key values, and executing a normalized exponential function on a combination of the attention weights and the correlation of the classification query output and the multiple key values, to generate the crossing intention prediction output.

In other features, executing the machine learning model includes combining an output of the normalized exponential function with the multiple key values to generate an embedding vector, and supplying the embedding vector to a multilayer perceptron to generate the crossing intention prediction output.

In other features, supplying training data and testing data to the machine learning model, comparing multiple crossing intention prediction outputs of the machine learning model, based on the training data, to labeled crossing intention outputs of the testing data, determining whether an accuracy of a comparison is greater than or equal to a specified accuracy threshold, adjusting parameters of the machine learning model and retraining the machine learning model, in response to a determination that the accuracy of the comparison is less than the specified accuracy threshold, and saving the machine learning model for use in generating crossing intention prediction output, in response to a determination that the accuracy of the comparison is greater than or equal to the specified accuracy threshold.

In other features, the image includes at least a forty-five degree field of view from the at least one vehicle camera. In other features, the one or more objects include at least one of a crosswalk, a traffic light, or another vehicle.

A vehicle control system for controlling vehicle braking based on vehicle camera image processing includes at least one vehicle camera configured to obtain an image from a front of a host vehicle, and a vehicle control module of the host vehicle. The vehicle control module is configured to extract machine learning model feature inputs based on the obtained image, detect one or more objects in the obtained image, the one or more objects including at least one pedestrian, assign attention weights to regions of the obtained image according to locations of the one or more objects in the obtained image, combine the attention weights with corresponding ones of the machine learning model feature inputs according to the regions of the obtained image, execute a machine learning model to generate a crossing intention prediction output associated with the at least one pedestrian, and in response to the crossing intention prediction output exceeding a crossing intention threshold, control automatic braking of the host vehicle according to a location of the at least one pedestrian.

In other features, the vehicle control module is configured to assign the attention weights by assigning a first intensity value to a first region of the obtained image corresponding to the at least one pedestrian, and assigning a second intensity value to a second region of the obtained image which does not correspond to the at least one pedestrian, and the first intensity value is greater than the second intensity value.

In other features, the vehicle control module is configured to assign the attention weights and the machine learning model feature inputs by generating a weighted sum of the machine learning model feature inputs, according to the attention weights.

In other features, the machine learning model includes a multilayer perceptron, and the vehicle control module is configured to execute the machine learning model by generating the crossing intention prediction output according to an output of the multilayer perceptron.

In other features, the vehicle control module is configured to extract the machine learning model feature inputs based on the obtained image by supplying the obtained image to multiple visual transformer layers to generate the machine learning model feature inputs.

In other features, the vehicle control module is configured to executing the machine learning model by obtaining multiple key values according to the machine learning model feature inputs, executing a classification query according to the machine learning model feature inputs, and correlating a classification query output with the multiple key values.

In other features, the vehicle control module is configured to executing the machine learning model by combining the attention weights with a correlation of the classification query output and the multiple key values, and executing a normalized exponential function on a combination of the attention weights and the correlation of the classification query output and the multiple key values, to generate the crossing intention prediction output.

In other features, the vehicle control module is configured to executing the machine learning model by combining an output of the normalized exponential function with the multiple key values to generate an embedding vector, and supplying the embedding vector to a multilayer perceptron to generate the crossing intention prediction output.

In other features, the image includes at least a forty-five degree field of view from the at least one vehicle camera, and the one or more objects include at least one of a crosswalk, a traffic light, or another vehicle.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram of an example vehicle including a front vehicle camera configured to capture images of pedestrians and traffic objects ahead of the vehicle.

FIG. 2 is a block diagram of an example system for predicting a pedestrian crossing intention based on image processing of a vehicle camera image.

FIG. 3 is a block diagram illustrating an example machine leaning model architecture of the system of FIG. 2.

FIG. 4 is a flowchart depicting an example process for predicting a pedestrian crossing intention based on image processing of a vehicle camera image.

FIGS. 5A and 5B are graphical representations of example recurrent neural networks for predicting a pedestrian crossing intention based on image processing of a vehicle camera image.

FIG. 6 is a graphical representation of layers of an example long short-term memory (LSTM) machine learning model.

FIG. 7 is a flowchart illustrating an example process for training a machine learning model.

In the drawings, reference numbers may be reused to identify similar and/or identical elements.

### DETAILED DESCRIPTION

Pedestrians often stand and wait to cross a road on which the vehicle is travelling, which may present a collision risk if a pedestrian crosses into the road while the vehicle is driving. Some example embodiments herein include systems and methods for estimating crossing intentions of pedestrians using a vehicle camera image with a wide field of view (FOV). The wide FOV image effectively captures interactions between the pedestrian and various traffic objects, such as the road, a crosswalk, traffic lights, other vehicles, bus stops, etc.

However, the wide FOV image also contains additional pedestrians and unrelated information. Example embodiments described herein may focus a machine learning model (e.g., a neural network) on the pedestrian and the traffic objects that are of interest for estimating a crossing intention of the pedestrian.

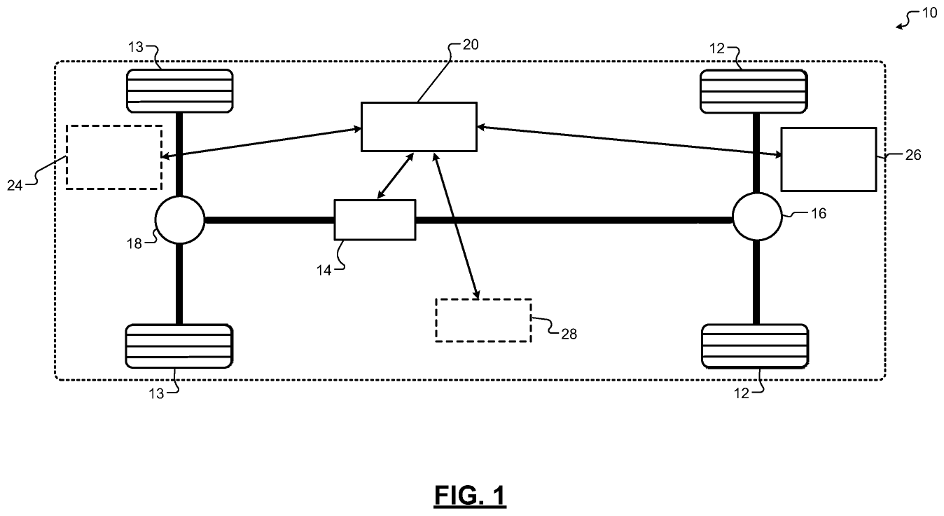

Referring now to FIG. 1, a vehicle 10 includes front wheels 12 and rear wheels 13. In FIG. 1, a drive unit 14 selectively outputs torque to the front wheels 12 and/or the rear wheels 13 via drive lines 16, 18, respectively. The vehicle 10 may include different types of drive units. For example, the vehicle may be an electric vehicle such as a battery electric vehicle (BEV), a hybrid vehicle, or a fuel cell vehicle, a vehicle including an internal combustion engine (ICE), or other type of vehicle.

Some examples of the drive unit 14 may include any suitable electric motor, a power inverter, and a motor controller configured to control power switches within the power inverter to adjust the motor speed and torque during propulsion and/or regeneration. A battery system provides power to or receives power from the electric motor of the drive unit 14 via the power inverter during propulsion or regeneration.

While the vehicle 10 includes one drive unit 14 in FIG. 1, the vehicle 10 may have other configurations. For example, two separate drive units may drive the front wheels 12 and the rear wheels 13, one or more individual drive units may drive individual wheels, etc. As can be appreciated, other vehicle configurations and/or drive units can be used.

The vehicle control module 20 may be configured to control operation of one or more vehicle components, such as the drive unit 14 (e.g., by commanding torque settings of an electric motor of the drive unit 14). The vehicle control module 20 may receive inputs for controlling components of the vehicle, such as signals received from a steering wheel, an acceleration paddle, a vehicle camera, etc. The vehicle control module 20 may monitor telematics of the vehicle for safety purposes, such as vehicle speed, vehicle location, vehicle braking and acceleration, etc.

The vehicle control module 20 may receive signals from any suitable components for monitoring one or more aspects of the vehicle, including one or more vehicle sensors (such as cameras, microphones, pressure sensors, wheel position sensors, location sensors such as global positioning system (GPS) antennas, etc.). Some sensors may be configured to monitor current motion of the vehicle, acceleration of the vehicle, steering torque, etc.

As shown in FIG. 1, the vehicle 10 includes a front vehicle camera 26, configured to capture images of a field of view in front of the vehicle 10. The field of view may be a wide field of view (such as a least a thirty degree field of view, a forty-five degree field of view, a sixty degree field of view, a ninety degree field of view, etc.), in order to capture objects on sides of a road on which the vehicle 10 is traveling.

The vehicle 10 may include an optional rear vehicle camera 24, and an optional side vehicle camera 28. In various implementations, the vehicle 10 may include more or less of any of these optional vehicle cameras. The vehicle 10 may include any suitable laser, lidar sensor, etc., which is used to detect objects around the vehicle 10.

In some example embodiments, a vehicle object detector may be configured to detect a closest in-path vehicle (CIPV) (e.g., another vehicle in front of a current driving path of the vehicle 10), a vulnerable road user (VRU) (e.g., a pedestrian or cyclist), etc. The vehicle control module 20 may be configured to control movement of the vehicle 10 based on a detected CIP target vehicle, such as by increasing or decreasing automated acceleration of the vehicle 10, automatically applying brakes of the vehicle 10 (such as in response to a crash imminent braking event), etc.

The vehicle control module 20 may communicate with another device via a wireless communication interface, which may include one or more wireless antennas for transmitting and/or receiving wireless communication signals. For example, the wireless communication interface may communicate via any suitable wireless communication protocols, including but not limited to vehicle-to-everything (V2X) communication, Wi-Fi communication, wireless area network (WAN) communication, cellular communication, personal area network (PAN) communication, short-range wireless communication (e.g., Bluetooth), etc. The wireless communication interface may communicate with a remote computing device over one or more wireless and/or wired networks. Regarding the vehicle-to-vehicle (V2X) communication, the vehicle 10 may include one or more V2X transceivers (e.g., V2X signal transmission and/or reception antennas).

The vehicle 10 also includes a user interface. The user interface may include any suitable displays (such as on a dashboard, a console, or elsewhere), a touchscreen or other input devices, speakers for generation of audio, etc.

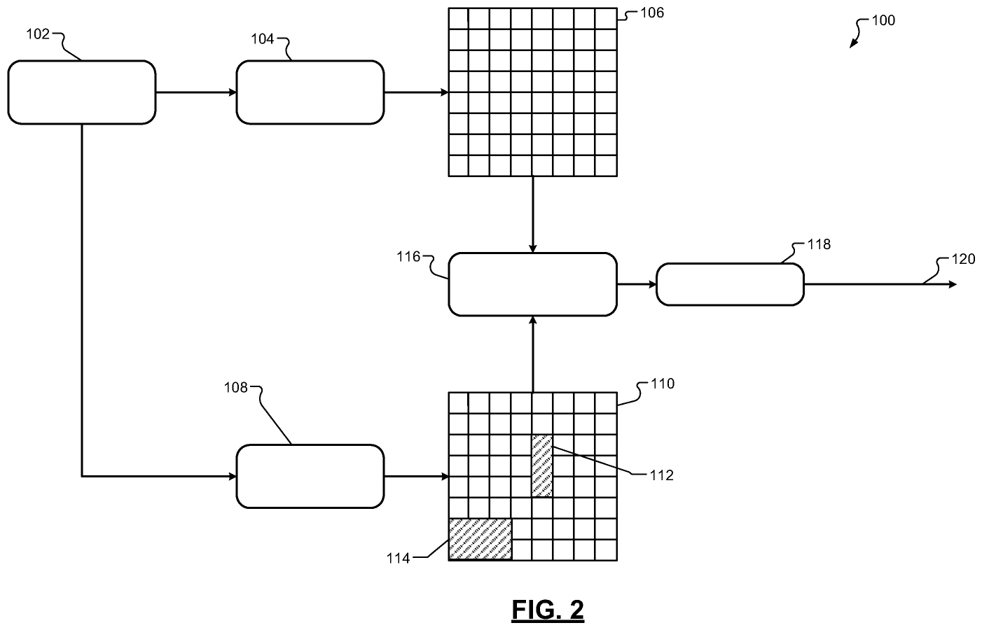

FIG. 2 is a block diagram of an example system 100 for predicting a pedestrian crossing intention based on image processing of a vehicle camera image. Components of the system 100 may be executed by, for example, the vehicle control module 20 of FIG. 1.

The vehicle control module 20 is configured to obtain a vehicle camera image 102 from a vehicle camera, such as the front vehicle camera 26. At 104, the vehicle control module 20 is configured to extract features for image processing by a machine learning model. For example, as explained further below, the vehicle camera image 102 may be supplied to multiple visual transformer layers, to generate multiple output features 106. In some examples, the multiple output features 106 may be arranged in a three-dimensional array with of M by N rows and columns, and C channels.

In a separate process from the feature extraction, the vehicle camera image 102 is supplied to a traffic object detection model 108, to detect traffic and pedestrian objects in the vehicle camera image 102. For example, one or more object detection algorithms, machine learning models, etc., may process the vehicle camera image 102 to identify pedestrians and traffic objects in the image. Example traffic objects may include, but are not limited to, traffic lights, crosswalks, sidewalks, vehicles, traffic signs, etc.

FIG. 2 illustrates an object detection output 110 divided into multiple regions, with identified objects in shaded boxes. For example, a detected pedestrian 112 may be identified in a vertical bounding box corresponding to three regions of the object detection output 110, and a detected crosswalk object 114 may be identified by a horizontal bounding box corresponding to six other regions of the object detection output 110.

The vehicle control module 20 is configured to assign attention weights to regions of the vehicle camera image 102 having detected objects. For example, the vehicle camera image 102 may be divided into a grid of regions (e.g., squares, patches, etc.) in the object detection output 110, and regions in the grid that correspond to detected objects (such as the crosswalk object 114) or pedestrians (such as the pedestrian 112) may be assigned higher attention weights than regions that do not have corresponding detected objects.

The vehicle control module 20 is configured to combine the attention weights with the extracted features (e.g., the multiple output features 106) for each image region, at 116. For example, a weighted sum may be generated by applying the assigned attention weight for each region to the extracted output features of the image region. In this example, higher intensity due to the higher attention weights may bias the machine learning model to focus on areas of the image where detected pedestrians or traffic objects are located.

The vehicle control module 20 is configured to execute a machine learning model to generate a crossing intention prediction output. For example, the multiple output features 106, as modified by the attention weights from the object detection output 110, may be supplied to a multilayer perceptron (MLP) 118 or other suitable machine learning model to generate a pedestrian crossing intention prediction output 120.

The pedestrian crossing intention prediction output 120 may indicate a likelihood of whether an identified pedestrian (such as the pedestrian 112) is planning to cross a street on which the host vehicle is driving. For example, the vehicle control module 20 may determine whether the pedestrian crossing intention prediction output 120 is greater than a specified threshold (such as a 30% likelihood of intending to cross, a 50% likelihood, an 80% likelihood, etc.).

The crossing intention may be used by various systems in the vehicle 10, such as displaying the identified pedestrian on a display of the vehicle along with a predicted crossing intention indicator (so the driver is aware of a pedestrian that may be planning to cross the street ahead of the vehicle), generating an audible or tactile alert to the driver, controlling automatic braking to apply vehicle brakes to slow the vehicle as the vehicle approaches the identified pedestrian, etc.

For example, if automatic braking is activated in the vehicle, the vehicle control module 20 may be configured to apply brakes of the vehicle 10 according to a location of the detected pedestrian (e.g., based on a time to collision with the identified pedestrian 112, etc.).

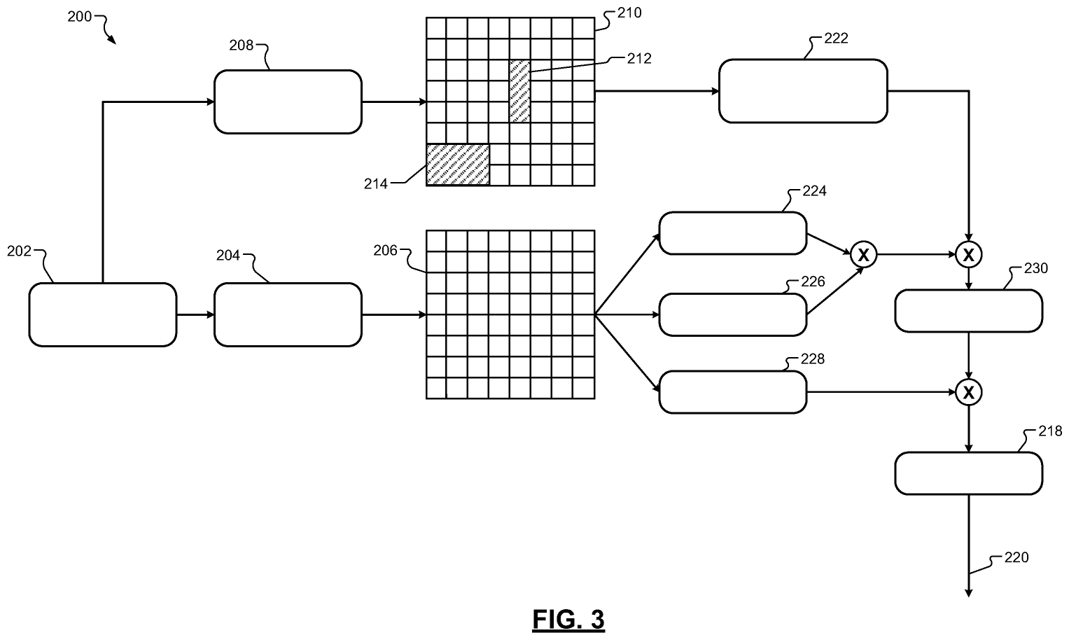

FIG. 3 is a block diagram illustrating an example machine leaning model architecture 200 of the system of FIG. 2. A vehicle camera image 202 is supplied to multiple visual transformer layers 204, to generate extracted output features 206 (which may be arranged in an array of M by N columns, with each element having C channels).

The vehicle camera image 202 is also supplied to a traffic object detection model 208, to generate an object detection output 210. The object detection output 210 includes a detected pedestrian 212 and a detected crosswalk object 214, but may also include other types of detected objects.

At 222, the vehicle control module 20 is configured to assign crossing intention attention weights to various regions of the vehicle camera image 202. For example regions of the vehicle camera image corresponding to detected traffic objects, such as the crosswalk object 214, may have a higher likelihood of being relevant to an accurate prediction of whether the pedestrian 212 is intending to cross the street.

As shown in FIG. 3, multiple keys 224 may be obtained from the extracted output features 206, and a classification (CLS) query 226 may be run on the extracted output features 206. The multiple keys 224 (which may be represented by (NM)xC parameters), may be correlated with the CLS query 226 (which may be represented by a channel Cx1), to generate a correlated output (NM).

The correlated output may be joined with the attention weights, and supplied to a normalized exponential function 230 (e.g., a normalization Softmax function), to generate an output of dimension (NM). This output may be combined with values 228 of the extracted output features 206, to generate an embedding vector of dimension (C). The embedding vector is supplied to a classification MLP head 218, to generate the crossing intention prediction output 220.

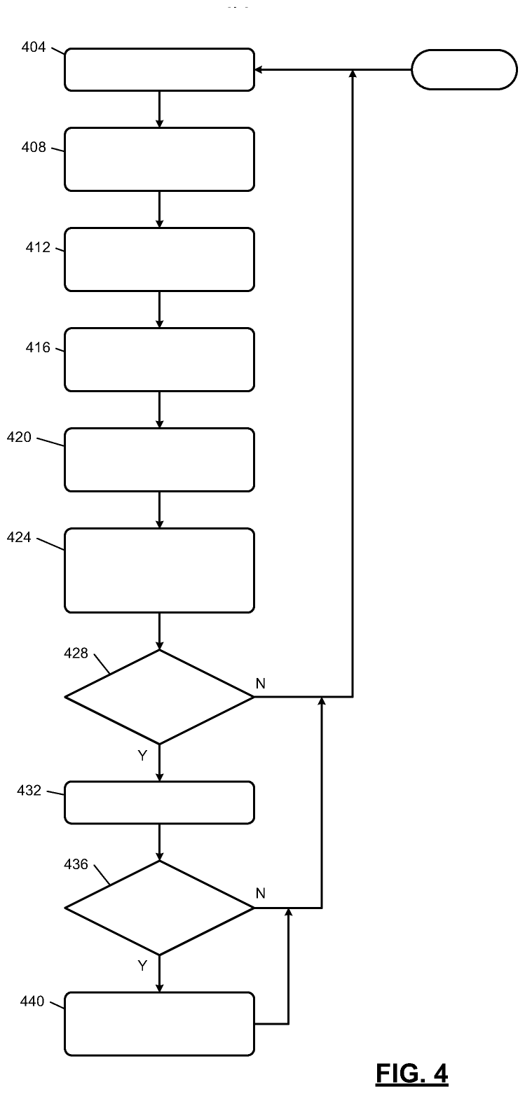

FIG. 4 is a flowchart depicting an example process for predicting a pedestrian crossing intention based on image processing of a vehicle camera image. The process illustrated in FIG. 4 may be performed by, for example, the vehicle control module 20 of FIG. 1. At 404, the process begins by obtaining an image from a vehicle camera, such as the front vehicle camera 26 of FIG. 1.

At 408, the vehicle control module is configured to extract features for image processing by a machine learning model. For example, the image obtained by the vehicle camera may be supplied to multiple visual transformer layers, to generate multiple output features. In some examples, the multiple output features may be arranged in a three-dimensional array with of M by N rows and columns, and C channels.

At 412, the vehicle control module is configured to detect traffic and pedestrian objects in the obtained image. For example, one or more object detection algorithms, machine learning models, etc., may process the obtained image to identify pedestrians and traffic objects in the image. Example traffic objects may include, but are not limited to, traffic lights, crosswalks, sidewalks, vehicles, traffic signs, etc.

The vehicle control module is configured to assign attention weights to regions of the image having detected objects, at 416. For example, the image may be divided into a grid of regions (e.g., squares, patches, etc.), and regions in the grid that correspond to detected objects or pedestrians may be assigned higher attention weights than regions that do not have corresponding detected objects.

At 420, the vehicle control module is configured to combine the attention weights with extracted features for each image region. For example, a weighted sum may be generated by applying the assigned attention weight for each region to the extracted output features of the image region. In this example, higher intensity due to the higher attention weights may bias the machine learning model to focus on areas of the image where detected pedestrians or traffic objects are located.

At 424, the vehicle control module is configured to execute a machine learning model to generate a crossing intention prediction output. For example, the output features, as modified by the attention weights, may be supplied to a multilayer perceptron (MLP) or other suitable machine learning model to generate a pedestrian crossing intention prediction output.

The pedestrian crossing intention prediction output may indicate a likelihood of whether an identified pedestrian is planning to cross a street on which the host vehicle is driving. At 428, control determines whether the pedestrian crossing intention prediction output is greater than a specified threshold (such as a 30% likelihood of intending to cross, a 50% likelihood, an 80% likelihood, etc.).

If the pedestrian crossing intention prediction output is not greater than the specified crossing intention threshold, control returns to 404 to obtain another image from the vehicle camera. If the pedestrian crossing intention prediction output is greater than the specified crossing intention threshold at 428, control proceeds to 432 to assign a crossing intention to the identified pedestrian.

The crossing intention may be used by various systems in the vehicle, such as displaying the identified pedestrian on a display of the vehicle along with a predicted crossing intention indicator (so the driver is aware of a pedestrian that may be planning to cross the street ahead of the vehicle), generating an audible or tactile alert to the driver, controlling automatic braking to apply vehicle brakes to slow the vehicle as the vehicle approaches the identified pedestrian, etc.

For example, at 436 the vehicle control module is configured to determine whether automatic braking is activated in the vehicle. If so, control proceeds to 440 to apply brakes of the vehicle according to a location of the detected pedestrian (e.g., based on a time to collision with the identified pedestrian, etc.). Control then returns to 404 to obtain another image from the vehicle camera.

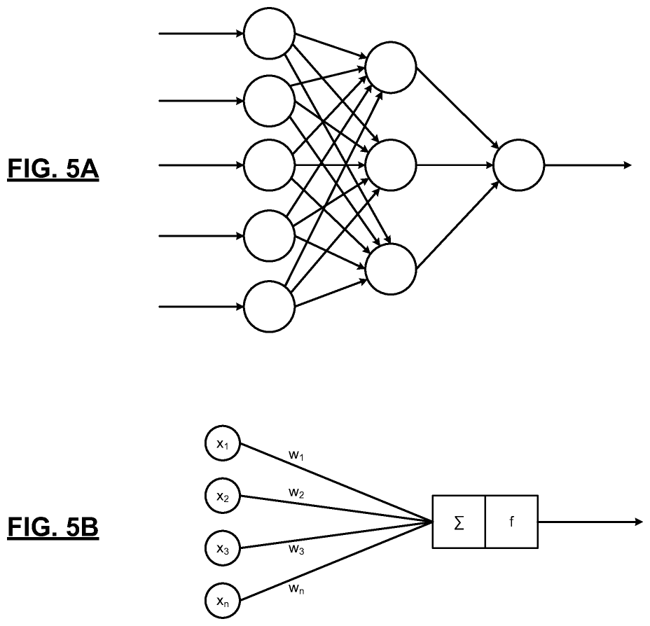

In various implementations, machine learning models may be used to generate pedestrian crossing intention prediction outputs. Examples of various types of machine learning models that may be used for automated vehicle camera image processing are described below and illustrated in FIGS. 5-7, but example embodiments are not limited thereto (and may include transformer layers, multilayer perceptrons, etc.).

FIGS. 5A and 5B show an example of a recurrent neural network used to generate models such as those described above, using machine learning techniques. Machine learning is a method used to devise complex models and algorithms that lend themselves to prediction (for example, patient and provider matching predictions). The models generated using machine learning, such as those described above, can produce reliable, repeatable decisions and results, and uncover hidden insights through learning from historical relationships and trends in the data.

The purpose of using the recurrent neural-network-based model, and training the model using machine learning as described above, may be to directly predict dependent variables without casting relationships between the variables into mathematical form. The neural network model includes a large number of virtual neurons operating in parallel and arranged in layers. The first layer is the input layer and receives raw input data. Each successive layer modifies outputs from a preceding layer and sends them to a next layer. The last layer is the output layer and produces output of the system.

FIG. 5A shows a fully connected neural network, where each neuron in a given layer is connected to each neuron in a next layer. In the input layer, each input node is associated with a numerical value, which can be any real number. In each layer, each connection that departs from an input node has a weight associated with it, which can also be any real number (see FIG. 5B). In the input layer, the number of neurons equals number of features (columns) in a dataset. The output layer may have multiple continuous outputs.

The layers between the input and output layers are hidden layers. The number of hidden layers can be one or more (one hidden layer may be sufficient for most applications). A neural network with no hidden layers can represent linear separable functions or decisions. A neural network with one hidden layer can perform continuous mapping from one finite space to another. A neural network with two hidden layers can approximate any smooth mapping to any accuracy.

The number of neurons can be optimized. At the beginning of training, a network configuration is more likely to have excess nodes. Some of the nodes may be removed from the network during training that would not noticeably affect network performance. For example, nodes with weights approaching zero after training can be removed (this process is called pruning). The number of neurons can cause under-fitting (inability to adequately capture signals in dataset) or over-fitting (insufficient information to train all neurons; network performs well on training dataset but not on test dataset).

Various methods and criteria can be used to measure performance of a neural network model. For example, root mean squared error (RMSE) measures the average distance between observed values and model predictions. Coefficient of Determination (R2) measures correlation (not accuracy) between observed and predicted outcomes. This method may not be reliable if the data has a large variance. Other performance measures include irreducible noise, model bias, and model variance. A high model bias for a model indicates that the model is not able to capture true relationship between predictors and the outcome. Model variance may indicate whether a model is stable (a slight perturbation in the data will significantly change the model fit). The neural network can receive inputs, e.g., vectors, that can be used to generate models that can be used with provider matching, risk model processing, or both, as described herein.

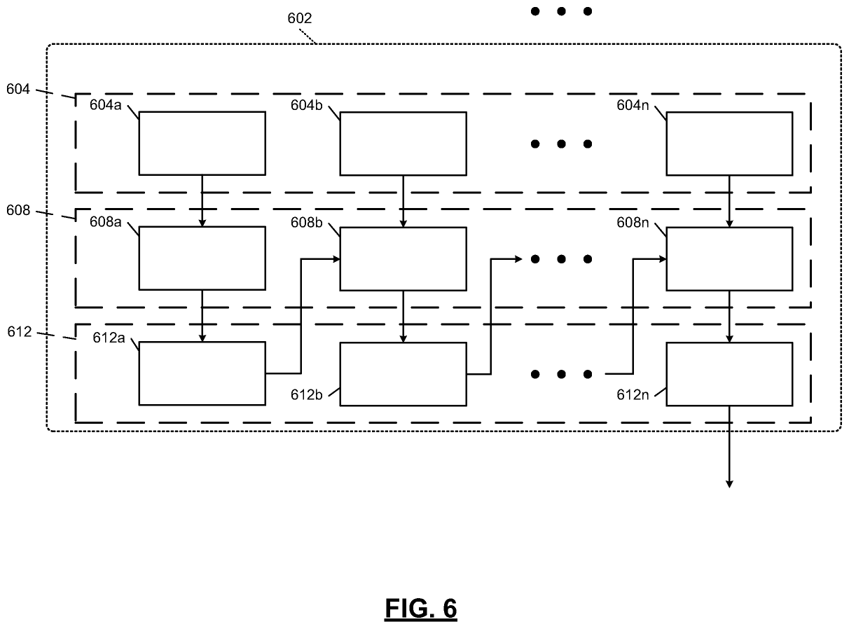

FIG. 6 illustrates an example of a long short-term memory (LSTM) neural network 602 used to generate models such as those described above, using machine learning techniques, although other example embodiments may include other types of machine learning models including transformer layers, multilayer perceptrons, etc. The generic example LSTM neural network 602 may be used to implement a machine learning model, and various implementations may use other types of machine learning networks (such as transformer layers, multilayer perceptrons, etc.). The LSTM neural network 602 includes an input layer 604, a hidden layer 608, and an output layer 612. The input layer 604 includes inputs 604a, 604b . . . 604n. The hidden layer 608 includes neurons 608a, 608b . . . 608n. The output layer 612 includes outputs 612a, 612b . . . 612n.

Each neuron of the hidden layer 608 receives an input from the input layer 604 and outputs a value to the corresponding output in the output layer 612. For example, the neuron 608a receives an input from the input 604a and outputs a value to the output 612a. Each neuron, other than the neuron 608a, also receives an output of a previous neuron as an input. For example, the neuron 608b receives inputs from the input 604b and the output 612a. In this way the output of each neuron is fed forward to the next neuron in the hidden layer 608. The last output 612n in the output layer 612 outputs a probability associated with the inputs 604a-604n. Although the input layer 604, the hidden layer 608, and the output layer 612 are depicted as each including three elements, each layer may contain any number of elements.

In various implementations, each layer of the LSTM neural network 602 must include the same number of elements as each of the other layers of the LSTM neural network 602. In some example embodiments, a convolutional neural network may be implemented. Similar to LSTM neural networks, convolutional neural networks include an input layer, a hidden layer, and an output layer. However, in a convolutional neural network, the output layer includes one fewer output than the number of neurons in the hidden layer and each neuron is connected to each output. Additionally, each input in the input layer is connected to each neuron in the hidden layer. In other words, input 604a is connected to each of neurons 608a, 608b . . . 608n.

In various implementations, each input node in the input layer may be associated with a numerical value, which can be any real number. In each layer, each connection that departs from an input node has a weight associated with it, which can also be any real number. In the input layer, the number of neurons equals number of features (columns) in a dataset. The output layer may have multiple continuous outputs.

As mentioned above, the layers between the input and output layers are hidden layers. The number of hidden layers can be one or more (one hidden layer may be sufficient for many applications). A neural network with no hidden layers can represent linear separable functions or decisions. A neural network with one hidden layer can perform continuous mapping from one finite space to another. A neural network with two hidden layers can approximate any smooth mapping to any accuracy. The neural network of FIG. 6 can receive inputs, e.g., vectors, that can be used to generate models that can be used with vehicle camara images for generating pedestrian crossing intention prediction outputs, as described herein.

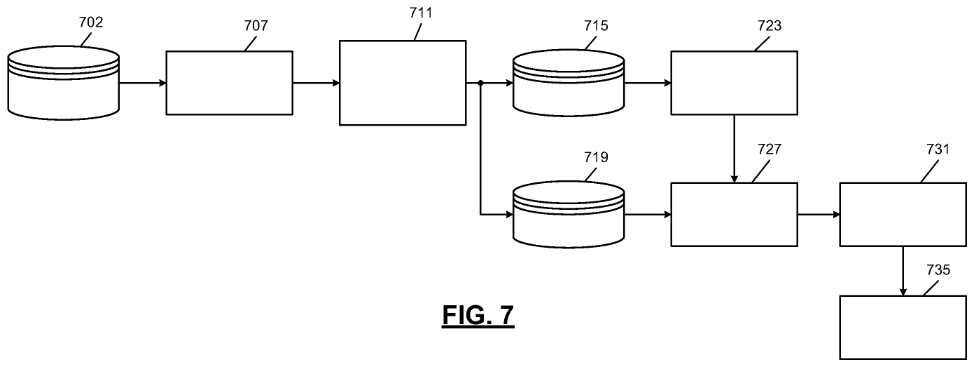

FIG. 7 illustrates an example process for generating a machine learning model. At 707, control obtains data from a database 702 (e.g., a data warehouse). The data may include any suitable data for developing machine learning models.

At 711, control separates the data obtained from the database 702 into training data 715 and test data 719. The training data 715 is used to train the model at 723, and the test data 719 is used to test the model at 727. Typically, the set of training data 715 is selected to be larger than the set of test data 719, depending on the desired model development parameters. For example, the training data 715 may include about seventy percent of the data acquired from the database 702, about eighty percent of the data, about ninety percent, etc. The remaining thirty percent, twenty percent, or ten percent, is then used as the test data 719.

Separating a portion of the acquired data as test data 719 allows for testing of the trained model against actual output data, to facilitate more accurate training and development of the model at 723 and 727. The model may be trained at 723 using any suitable machine learning model techniques, including those described herein, such as random forest, generalized linear models, decision tree, and neural networks.

At 731, control evaluates the model test results. For example, the trained model may be tested at 727 using the test data 719, and the results of the output data from the tested model may be compared to actual outputs of the test data 719, to determine a level of accuracy. The model results may be evaluated using any suitable machine learning model analysis, such as the example techniques described further below.

After evaluating the model test results at 731, the model may be deployed at 835 if the model test results are satisfactory. Deploying the model may include using the model to make predictions for a large-scale input dataset with unknown outputs. If the evaluation of the model test results at 731 is unsatisfactory, the model may be developed further using different parameters, using different modeling techniques, using other model types, etc. The machine learning model method of FIG. 7 can receive inputs, e.g., vectors, that can be used to generate models that can be used with provider matching, risk model processing, or both, as described herein.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A method for controlling automated vehicle acceleration and braking, the method comprising:
obtaining an image using at least one vehicle camera of a host vehicle;
extracting machine learning model feature inputs based on the obtained image;
detecting one or more objects in the obtained image, the one or more objects including at least one pedestrian;
assigning attention weights to regions of the obtained image according to locations of the one or more objects in the obtained image;
combining the attention weights with corresponding ones of the machine learning model feature inputs according to the regions of the obtained image;
executing a machine learning model to generate a crossing intention prediction output associated with the at least one pedestrian; and
in response to the crossing intention prediction output exceeding a crossing intention threshold, controlling automatic braking of the host vehicle according to a location of the at least one pedestrian.

2. The method of claim 1, wherein assigning the attention weights includes:
assigning a first intensity value to a first region of the obtained image corresponding to the at least one pedestrian; and
assigning a second intensity value to a second region of the obtained image which does not correspond to the at least one pedestrian, and the first intensity value is greater than the second intensity value.

3. The method of claim 2, wherein combining the attention weights and the machine learning model feature inputs includes generating a weighted sum of the machine learning model feature inputs, according to the attention weights.

4. The method of claim 1, wherein:
the machine learning model includes a multilayer perceptron; and
executing the machine learning model includes generating the crossing intention prediction output according to an output of the multilayer perceptron.

5. The method of claim 1, wherein extracting machine learning model feature inputs based on the obtained image includes supplying the obtained image to multiple visual transformer layers to generate the machine learning model feature inputs.

6. The method of claim 1, wherein executing the machine learning model includes:
obtaining multiple key values according to the machine learning model feature inputs;
executing a classification query according to the machine learning model feature inputs; and
correlating a classification query output with the multiple key values.

7. The method of claim 6, wherein executing the machine learning model includes:
combining the attention weights with a correlation of the classification query output and the multiple key values; and
executing a normalized exponential function on a combination of the attention weights and the correlation of the classification query output and the multiple key values, to generate the crossing intention prediction output.

8. The method of claim 7, wherein executing the machine learning model includes:
combining an output of the normalized exponential function with the multiple key values to generate an embedding vector; and
supplying the embedding vector to a multilayer perceptron to generate the crossing intention prediction output.

9. The method of claim 1, further comprising:
supplying training data and testing data to the machine learning model;
comparing multiple crossing intention prediction outputs of the machine learning model, based on the training data, to labeled crossing intention outputs of the testing data;
determining whether an accuracy of a comparison is greater than or equal to a specified accuracy threshold;
adjusting parameters of the machine learning model and retraining the machine learning model, in response to a determination that the accuracy of the comparison is less than the specified accuracy threshold; and
saving the machine learning model for use in generating crossing intention prediction output, in response to a determination that the accuracy of the comparison is greater than or equal to the specified accuracy threshold.

10. The method of claim 1, wherein the image includes at least a forty-five degree field of view from the at least one vehicle camera.

11. The method of claim 10, wherein the one or more objects include at least one of a crosswalk, a traffic light, or another vehicle.

12. A vehicle control system for controlling vehicle braking based on vehicle camera image processing, the vehicle control system comprising:
at least one vehicle camera configured to obtain an image from a front of a host vehicle; and
a vehicle control module of the host vehicle, the vehicle control module configured to:
extract machine learning model feature inputs based on the obtained image;
detect one or more objects in the obtained image, the one or more objects including at least one pedestrian;
assign attention weights to regions of the obtained image according to locations of the one or more objects in the obtained image;
combine the attention weights with corresponding ones of the machine learning model feature inputs according to the regions of the obtained image;
execute a machine learning model to generate a crossing intention prediction output associated with the at least one pedestrian; and
in response to the crossing intention prediction output exceeding a crossing intention threshold, control automatic braking of the host vehicle according to a location of the at least one pedestrian.

13. The vehicle control system of claim 12, wherein the vehicle control module is configured to assign the attention weights by:
assigning a first intensity value to a first region of the obtained image corresponding to the at least one pedestrian; and
assigning a second intensity value to a second region of the obtained image which does not correspond to the at least one pedestrian, and the first intensity value is greater than the second intensity value.

14. The vehicle control system of claim 13, wherein the vehicle control module is configured to assign the attention weights and the machine learning model feature inputs by generating a weighted sum of the machine learning model feature inputs, according to the attention weights.

15. The vehicle control system of claim 12, wherein:
the machine learning model includes a multilayer perceptron; and
the vehicle control module is configured to execute the machine learning model by generating the crossing intention prediction output according to an output of the multilayer perceptron.

16. The vehicle control system of claim 12, wherein the vehicle control module is configured to extract the machine learning model feature inputs based on the obtained image by supplying the obtained image to multiple visual transformer layers to generate the machine learning model feature inputs.

17. The vehicle control system of claim 12, wherein the vehicle control module is configured to executing the machine learning model by:
obtaining multiple key values according to the machine learning model feature inputs;
executing a classification query according to the machine learning model feature inputs; and
correlating a classification query output with the multiple key values.

18. The vehicle control system of claim 17, wherein the vehicle control module is configured to executing the machine learning model by:
combining the attention weights with a correlation of the classification query output and the multiple key values; and
executing a normalized exponential function on a combination of the attention weights and the correlation of the classification query output and the multiple key values, to generate the crossing intention prediction output.

19. The vehicle control system of claim 18, wherein the vehicle control module is configured to executing the machine learning model by:
combining an output of the normalized exponential function with the multiple key values to generate an embedding vector; and
supplying the embedding vector to a multilayer perceptron to generate the crossing intention prediction output.

20. The vehicle control system of claim 19, wherein:
the image includes at least a forty-five degree field of view from the at least one vehicle camera; and
the one or more objects include at least one of a crosswalk, a traffic light, or another vehicle.
